(19) United States
(12) Patent Application Publication
(10) Pub. No.: US 2019/0066049 A1
(43) Pub. Date: Feb. 28, 2019

(54) SYSTEMS AND METHODS FOR THE ESTIMATION AND SALES OF BUILDING PRODUCTS

(71) Applicant: Remote Sales Force, LLC, Carmel, IN (US)

(72) Inventors: Christopher T. Thornberry, Indianapolis, IN (US); Mark F. Garringer, Eaton, IN (US); Kail F. Keusch, Westfield, IN (US)

(73) Assignee: Remote Sales Force, LLC, Carmel, IN (US)

(21) Appl. No.: 16/119,210

(22) Filed: Aug. 31, 2018

Related U.S. Application Data
(60) Provisional application No. 62/552,451, filed on Aug. 31, 2017.
(60) Provisional application No. 62/552,458, filed on Aug. 31, 2017.
(60) Provisional application No. 62/552,466, filed on Aug. 31, 2017.
(60) Provisional application No. 62/552,472, filed on Aug. 31, 2017.

(51) Int. Cl. G06Q 10/08; G06Q 30/06; G06Q 30/02; G06F 17/30

(52) U.S. Cl. CPC G06Q 10/0875; G06Q 30/0633; G06Q 50/08; G06F 17/30864; G06Q 30/0283

(57) ABSTRACT

One form of the present application is directed to a system for the estimation of building materials, which includes a remote terminal associated with a construction product for which can be placed in communication with a server. A measurement data repository application is accessible from the remote terminal and is configured to generate a measurement import page on the remote terminal which includes a category of measurement input field and a measurement value input field. A product pricing data repository is accessible from the remote terminal and is configured to store product ng data and product measurement data, wherein such data can be updated from the server. A generate estimate application accessible front the remote terminal is configured to generate an estimate on the remote terminal in response to the category of measurement, the measurement value, the product pricing data, and the product measurement data.

### CROSS REFERENCE TO RELATED APPLICATIONS

The present application claims the benefit of U.S. Provisional Application No. 62/552,472, filed Aug. 31, 2017, U.S. Provisional Application No. 62/552,451, filed Aug. 31, 2017, U.S. Provisional Application No. 62/552,466, filed Aug. 31, 2017, and U.S. Provisional Application No. 62/552,458, filed Aug. 31, 2017, the entire contents of which are expressly incorporated by reference herein.

### BACKGROUND

The technical field generally relates to the estimation and sales of building products. The estimation of building products and materials is a critical component of construction projects. As with most products and services, consumer decisions on construction costs and products are often driven by pricing; therefore, an accurate and competitive estimate can often make or break a potential sale.

The present process utilized for the estimation of building products can be extremely complex and time consuming. This complexity increases the chances of errors occurring during estimation and results in a substantial amount of time being spent to provide an estimate which accurately reflects the approximate cost of building materials and labor for a given construction project. Moreover, current estimation techniques typically involve adding multiple line items manually to an estimate one by one.

The complexity of estimation is due to a variety of factors, which include, but are not limited to, mixed units of measure as well as a large number of measurements. The current process requires an estimator to add a product to an estimate and then look up from a form of reference a measurement value, convert the unit of measure (if applicable), and enter that value in the estimate. FIG. 1 is a flow diagram depicting one form of estimation utilized in the prior art.

In this process, an estimate is created at 102. At 104 the item is selected. The measurements are obtained from an external resource at 106. An estimator will determine if the units of measure match the units for the building product at 108. If the units match, the value is entered in the unit field at 112. If the units do not match, the units are converted at 110, and this value is then entered in the unit field at 112. If any additional items are needed, those are entered at 114. The estimate is then completed at 116 and can then be given to the customer or potential customer.

Moreover, the current process of including additional product information documents into a document work product (e.g. a proposal, estimate, agreement, contract, scope of work, etc.) is a manual process. This process typically involves locating copies of product information (which could be printed or digital), ensuring the document is current, scanning them if they're printed, and adding them to the estimate or proposal. As would be understood to a person of skill in the art, this process is time consuming and prone to user error.

Furthermore, many companies have found it difficult to gather information on what actually happens on sales calls. The current process typically involves sales representatives (or other system users) to update information regarding the status of an appointment, job, estimate, or other record with a value (either from a predetermined list or a freeform box). This information is then used to generate reports on appointments, jobs, estimates, or the like to provide information regarding status, closing rates, or the like. As would be understood to a person of ordinary skill in the art, the present process is unreliable at best and very time consuming.

In light of the aforementioned problems with the prior art, further technological developments are desirable in this area.

### SUMMARY

One embodiment of the present application includes a unique system for integrating measurements into a construction estimate. Other embodiments include unique apparatuses, systems, and methods for: analytics and reporting on sales of building improvements; estimate templating for building projects; and automatic inclusion of additional product information in a document. Further embodiments, inventions, forms, objects, features, advantages, aspects, and benefits of the present application are otherwise set forth or become apparent from the description and drawings included herein.

### BRIEF DESCRIPTION OF HE DRAWINGS

The description herein makes reference to the accompanying drawings wherein like reference numerals refer to like parts throughout the several views, and wherein:

FIG. 1 depicts an estimate creation and measurement association process of the prior art;

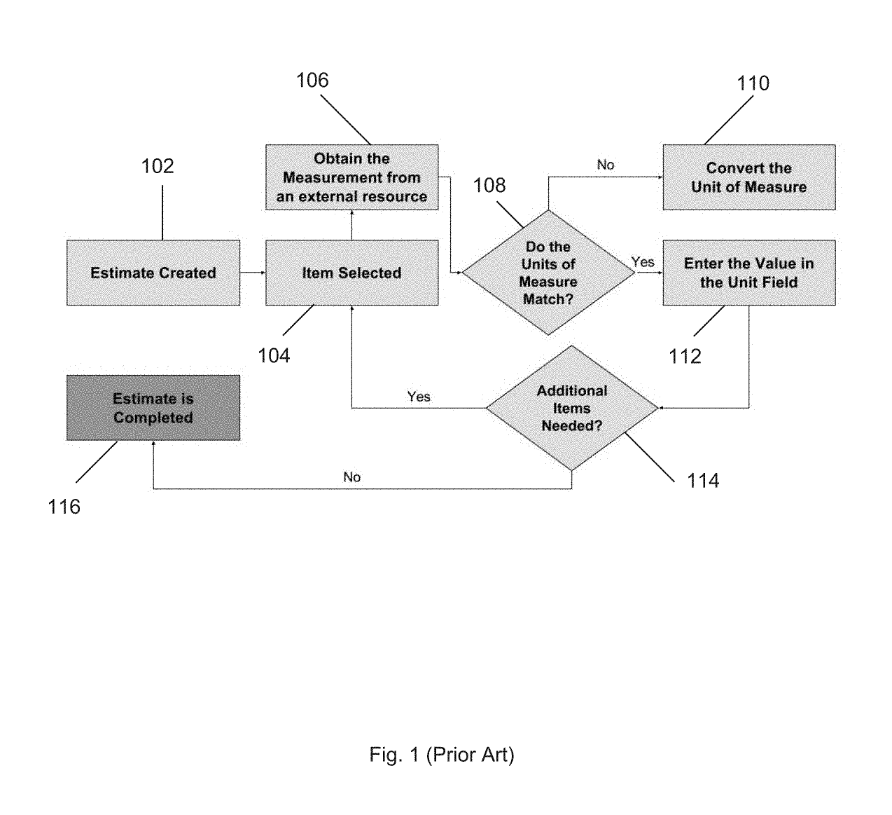

FIG. 2 depicts a measurement integrated estimation creation diagram according to one form of the present application;

FIG. 3 is a diagram of a unit of measure conversion engine of the present application;

FIG. 4 depicts an exemplary graphical user interface demonstrating a user manually entering a measurement;

FIG. 5 depicts an analytics event data gathering process according to another form of the present application;

FIG. 6 depicts an exemplary sample analytics report;

FIG. 7 depicts an exemplary sample verbose analytics event listing;

FIG. 8 depicts an exemplary estimate template creation process overview according to a further form of the present application;

FIG. 9 depicts an exemplary graphical user interface demonstrating a selected product example;

FIG. 10 is an example of available options for the graphical user interface of FIG. 9;

FIG. 11 depicts an estimate group example for the graphical user interface of FIG. 9;

FIG. 12 depicts a save as template example for the graphical user interface of FIG. 9;

FIG. 13 depicts a use existing template process overview flow diagram;

FIG. 14 depicts a flow diagram for automatic document inclusion according to another form of the present application; and

FIG. 15 is a schematic illustration of a brochure attached to a product.

### DETAILED DESCRIPTION

For purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated device, and any further applications of the principles of the invention as illustrated therein being contemplated as would normally occur to one skilled in the art to which the invention relates.

For ease of reference, the present application is delineated into four major subsections: integrating measurements into estimate creation; analytics and reporting on sales of building improvements; estimate templating for building projects; and automatic inclusion of additional product information in a document. It should be understood that each subsection may include one or more embodiments and concepts may be applied across subsections.

Integrating Measurements into Estimate Creation

One form of the present application is directed to a unique building estimation system which allows the user access to measurement values associated with the job. As will be described hereinafter, these measurement values can either be manually or automatically associated with the item on the estimate.

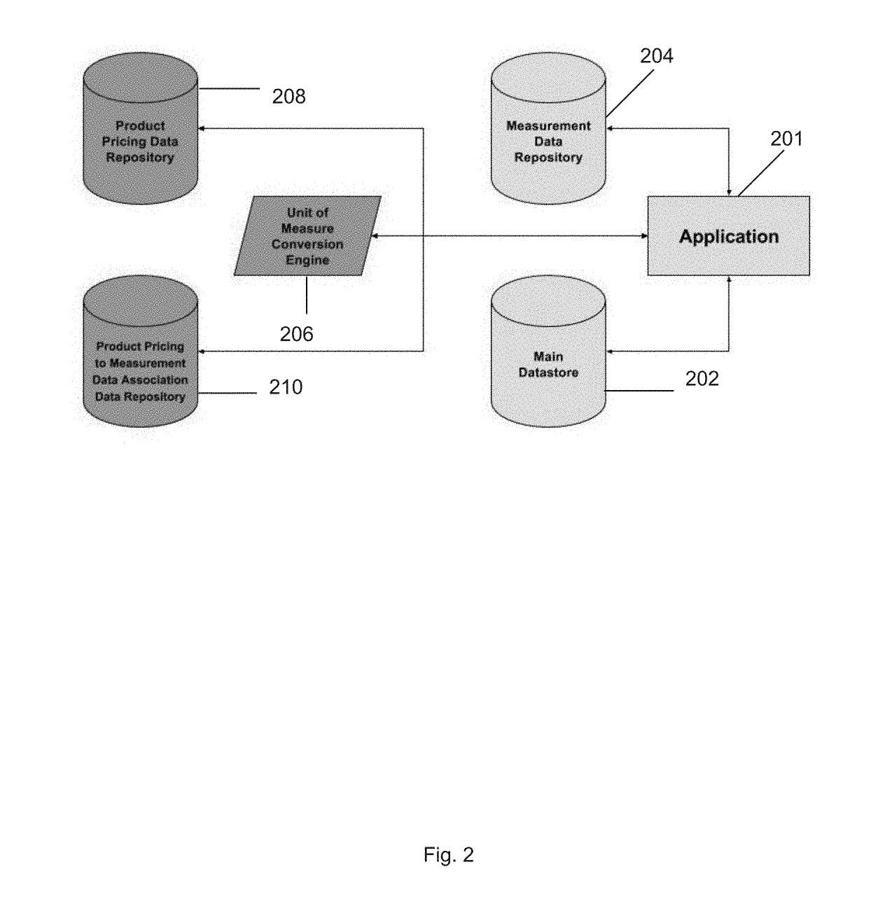

The integrated system of the present application makes the job of building estimates extremely easy by taking the manual effort and energy out of the process. FIG. 2 depicts a measurement integrated estimation creation diagram according to one form of the present application. As is illustrated, an application 201 is displayed on a remote terminal and displays a graphical user interface through which a user can interact with the system. A measurement data repository is depicted at 204 which stores measurement data input by an estimator. A main datastore is depicted at 202, a unit of measure conversion engine at 206, a product pricing data repository at 208, and a product pricing to measurement data association data repository at 210.

The measurement data repository 204 includes measurement records with items such as:

Category of Measurement
This could be a single or multiple levels.
A few examples could be: Exterior>Roofing, Exterior>Roofing>Decking, Exterior>Siding, Interior>Square Footage, Interior Upstairs>Square Footage, etc.

Measurement Type
Name
A few examples for a roofing application can include:
   Total Area
   First Level Area
   Second Level Area
   Low Slope Area
   High Slope Area
   6/12 Slope Area
   Ridge Length
   Hip Length
   Eave Length
   Rake Length
   Valley Length
   Flashing Length
   Roof Facet Area
   Etc.

Name
A name that can be associated with a given measurement record.

Unit of Measure
The unit of measure the measurement record is in.
A few exemplary units of measure are:
   Square Foot
   Square Meter
   Lineal Foot
   Lineal Meter
   Each
   Pair
   Etc.

Measurement Value
The value of the measurement record. This measurement value is the actual measurement input by the user into the graphical user interface.

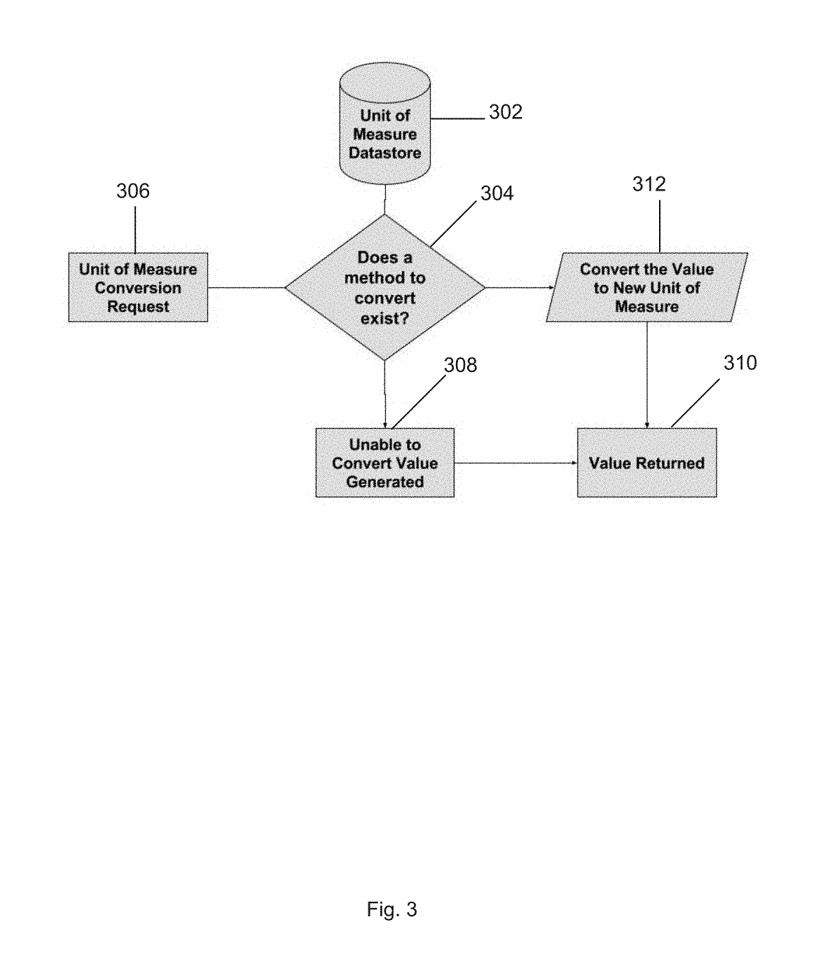

FIG. 3 depicts the measure conversion engine 206 of the present application. A unit of measure conversion request is depicted at 306, a unit of measure datastore is depicted at 302, whether a method to convert exists is determined at 304, if the conversion engine 206 is unable to convert value generated is depicted at 308, value returned is depicted at 310, and convert the value to new unit of measure is depicted at 312. Upon entry of a value to be converted, a source unit of measure, and a destination unit of measure, the measure conversion engine 206 consults the unit of measure datastore 302 to convert unit of measure to a product unit of measure.

This conversion engine 206 is utilized to convert the unit of measurement provided by an estimator into a unit of measurement of a product. For example, if an estimator is measuring in feet and the product is sold in meters, the conversion engine 206 can automatically perform such conversion.

In further forms, conversion engine 206 additionally can account for rounding and predetermined lengths. For example, the conversion engine 206 can be configured to always round up to a whole product unit. This whole unit can be the product measurement as sold (e.g. products are often sold in a set length or in a set package size). The conversion engine 206 can be configured to account for predetermined product lengths and/or the specific amount of product in a package.

The following is a demonstrative example of how the conversion engine 206 can account for product dimensional constraints. If a customer wants four inch wide cherry hardwood flooring to cover 100 ft², an estimator can enter this measurement value into the system (or it can be calculated by the system based on other measurements received by the estimator). The conversion engine 206 is then able to access the product pricing data repository 208 to determine what lengths/units the specific flooring the customer has chosen are available in (e.g. four in wide cherry hardwood flooring available in 21 ft² packages). The conversion engine 206 will then determine that to provide coverage for the 100 ft² area, five (5) 21 ft² packages of flooring will be required. The number of packages of material will then be output by the conversion engine 206 to be utilized by the system for further estimating (e.g. such as price calculation), or will be automatically entered into the estimate.

Referring back to FIG. 2, the product pricing data repository is depicted at 208. The product pricing data repository can include product information/records such as:

Name

Description

Unique Identifier
Something such as a UUID or other randomly generated and forced unique identifier.

Price

Unit of Measure

Images

Documents

The Product Pricing to Measurement Data Association Data Repository (hereinafter “PPMDADA”) is depicted at 210. The PPMDADA 210 is used to house records that will allow the system to automatically determine the appropriate measurement record in the measurement data repository 204 taken by the estimator This PPMDADA 210 can include records with items such as:

Product UUID

Measurement Value Calculation
This is a data structure that contains data that can be used by the invention to determine the appropriate measurement record to be used,
A few examples of this type of calculation could be:
   Always use a dynamic value:
      Use a Total Roof Area
      Or Use Ridge Length
   Always use a static value:
      Always return 3
      Or Always return 10
      etc.
   Return a value from predefined ranges:
      If Total Roof Area<1000 use
         Total Roof Area*1.10
      If Total Roof Area>1000 and Total Roof Area<2500 use
         Total Roof Area*1.15
      If Total Roof Area>2500 use
         Total Roof Area*1.25
   Return a selection of values:
      Choose from a list:
         Total Roof Area*1.10
         Total Roof Area*1.15
         Total Roof Area*1.25
   Other conditional processes

The information located in the measurement data repository 204 and unit conversion engine 206 can be used either in conjunction or separately. The system described in FIG. 2 can operate manually or automatically. An exemplary description of this process follows:

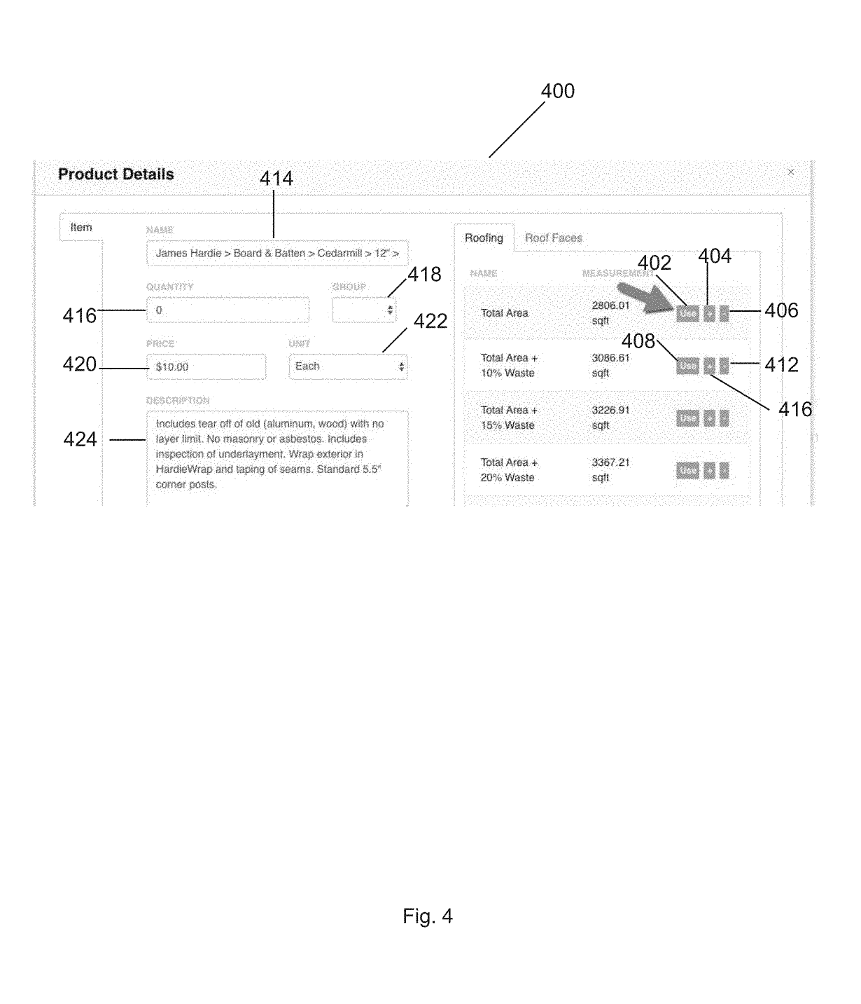

Manual:
User Adds or Edits an Item Onto the Estimate
   User accesses the measurement data repository 204 and selects a measurement value. If needed, the unit of measure conversion engine 206 would be accessed by the system to convert the unit based on the unit of measure. FIG. 4 depicts an exemplary graphical user interface 400 demonstrating how a user would manually enter a measurement. Graphical user interface 400 includes a product name field 414, a quantity of product field at 416, a group field at 418, a price field 420, and a unit of price field 422. A description of the product, installation of the product or other information relevant to the product can be displayed at 424. If a user decides to utilize the total area depicted, the user can click on 402 “use” or can manually add (+) 404 or subtract (−) 406 to the total area. The total area including waste at 10% can be used 408 or can be added to (+) 416 or subtracted from (−) 412, As would be understood to a person of skill in the art, a variety of waste estimations can be selected from which can depend upon the specific product, type of job, and/or size of job. a The unit of measure conversion engine 206 can be utilized to convert the unit of measure to the unit of product sold, as was previously described.

Automatic:
User Adds a Single Item from the Product Pricing Data Repository 208 to the Estimate
   The system can access the product pricing data repository 208 to determine the unit of measure the product is priced.
   The system can then access the PPMDADA 210 to determine the appropriate value from the measurement data repository 204.
      The system would then consult the measurement data repository 204 to determine the appropriate measurement value and unit of measure.
   The system could, then optionally, access the unit of measure conversion engine 206 and provide the needed inputs to get the unit in the appropriately converted unit of measure.
   The system would then enter the unit in the field for the newly added item on the estimate.
User Adds Multiple Items from the Product Pricing Data Repository 208 to the Estimate
   This follows a similar process as described above with a single item; however, it is performed for multiple items. This process could be done on a multiple items in a single operation by the user.

### System and Method for Analytics and Reporting on Sales of Building Improvements

One form of the present application is directed to a process for tracking and reporting on sales and estimation events which involves the automatic tracking of all interactions the user(s) have with the sales and/or estimation software systems. These interactions can include, but are not limited to, each and every click, keyboard entry, phone call, or the like that the sales representative and the customer has with the system.

This event information is then stored in a system with all applicable metadata to allow for later reporting. The reporting system allows users to be able to pose questions and use the underlying data to be able to answer these questions. Questions like “Was the customer presented with a warranty?” were historically unable to be answered because there was no reliable way for us to determine the answer. Now, since the system is integrated and knows each and every operation the answer is very easy to compute.

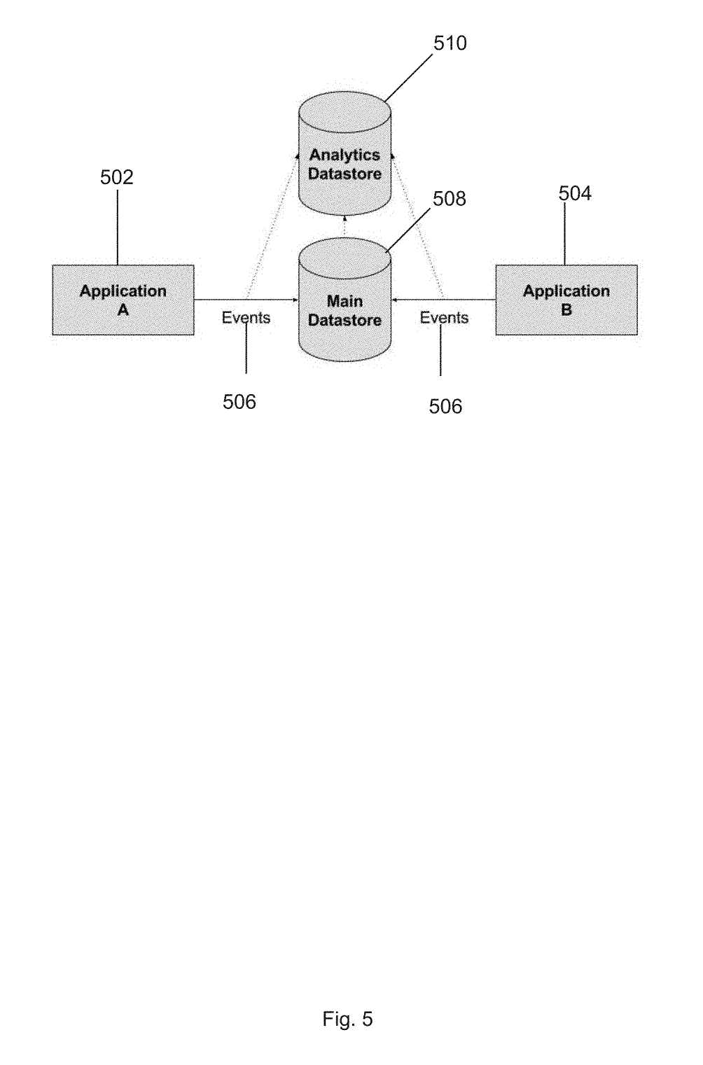

As would be understood to a person of skill in the art, there are a variety of ways to gather analytic event data. Although one specific process for gathering analytic event data will be described hereinafter, the present application is not intended to be limited to such. FIG. 5 depicts a process for analytics event data gathering through indirect and in-line event gathering. An estimator/salesperson can access the system via application A 502. A customer or third party can access the system via application B 504. A main datastore 508 permits communication between application A 502 and application B 504. An analytics datastore is depicted at 510 and houses any events 506 from application A 502 and application B 504.

When each specified event action is performed (successfully or unsuccessfully) the system automatically sends event data to the analytics datastore 510 for safekeeping.

An event 506 can include any interaction between the user and the system. Each event 506 has many data properties. A few examples of event 506 data properties include:

Date

Time

User

System

Client
Application Version (if applicable)
Browser Version (if applicable)
IP Address

Connectivity (was this event communicated directly or was it recorded offline and sent to the analytics system later)

Email Address (when an email is being used)

Phone Number (when an sms/text message is being used)

Objects being interacted with (array of individual objects)
id
type
name
action
result
metadata:
   For example, in the case of a presentation, the metadata retained can include the title of the slide deck and slide number.
      The following are descriptions of a few exemplary examples of event 506 data that could be tracked by the system:

Estimate Creation
When the user clicks to create the estimate.

Estimate Building
The addition, deletion, modification of each line item.

Saving Estimate
Was an estimate saved in the system?

Using Measurements on the Estimate
Measurement was used when adding or editing a line item on the proposal.

Sending the Estimate
The estimate was sent to the user via email or text message.

Send Appointment Invitation
The appointment was sent to the user via email or text message.

Presentation Display
The user opened a presentation.

Presentation Slide Changed
The user changed from a specific slide to another.

Screen Share Started
Screen share was activated.

Screen Share Viewer Connected
The remote viewer(s) connected to the screen share.

Screen Share Viewer Disconnected
The remove viewer(s) disconnected from the screen share.

Screen Share Stopped
The screen share was stopped.

Emailing Contract/Agreement
The contract/agreement was sent to the user via email or ext message.

Sending Contract/Agreement for Signature
The contract/agreement was sent to the user for signature via email or text message.

Contract/Agreement Opened by Signer(s)
The contract/agreement was opened by a user.

Contract/Agreement Signed by Signer(s)
The contract/agreement was signed by a user.

Contract/Agreement Completely Executed
The contract/agreement was signed/executed by all users,

Visualization Used
Visualization tool was used by the sales rep.

One component of this application is the reporting on the event 506 data that has been captured. The system allows us to ask simple and/or complex questions of the dataset we have. The questions are then evaluated by the system and available event 506 data to determine a result.

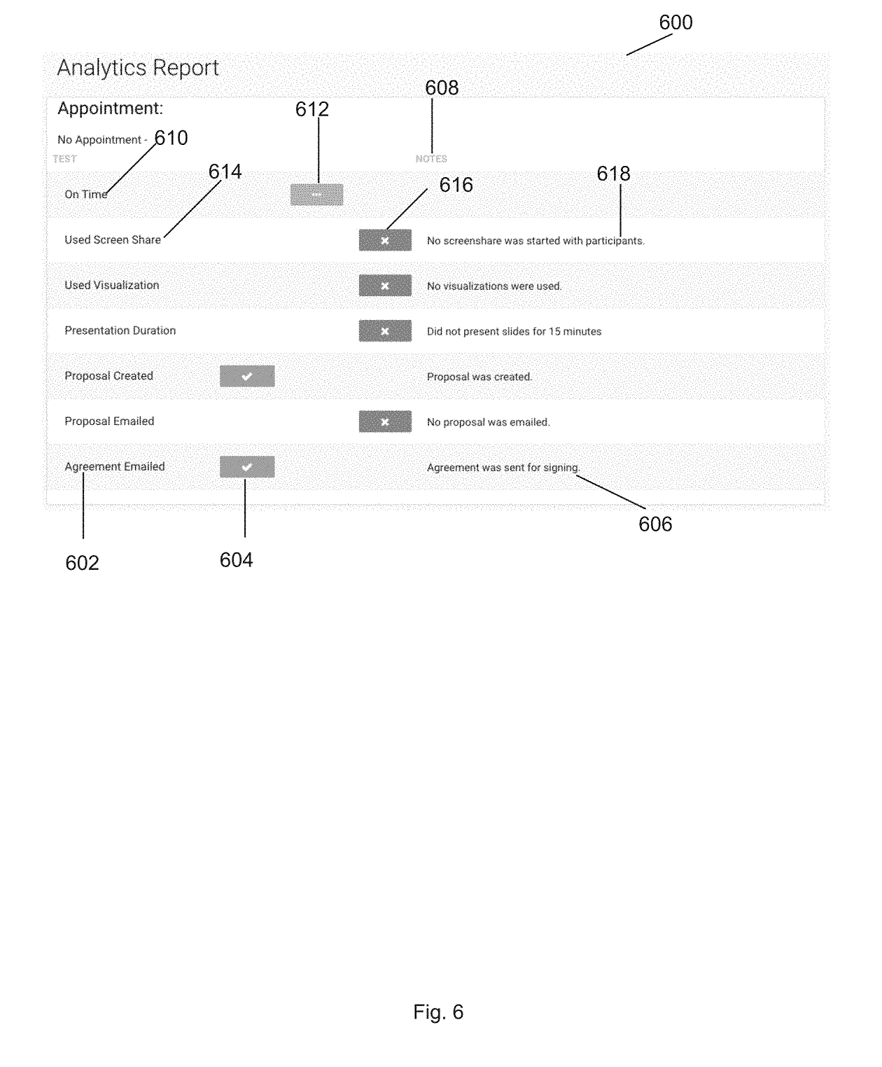

A result can be displayed in many ways. In one form, a color coding scheme can be utilized to display the status of a result, for example: green, yellow, red status. In an additional and/or alternative form visual icons can be utilized to depict a result status. FIG. 6 depicts an exemplary sample analytics report demonstrating this color coding and icon scheme. A graphical user interface 600 is depicted which illustrates a variety of events 506 and permits notes to be entered at 608. Whether the appointment was on time 610 is indicated by a ( . . . ) icon which demonstrates there is not enough event 506 data available to support this conclusion and is also depicted in yellow which additionally indicates there is not enough event 506 data available to support this conclusion. The (x) icon in red indications the event 506 data does not support the conclusion that screen share was used at 614. A note 618 stating “no screenshare was started with participants” is also included for this status. The (check) icon in green at 604 indicates the event 506 data supports the conclusion that an agreement was emailed 602. Additionally at 606 a note was entered stating “agreement was sent for signing.”

The following are a few examples of analytics reporting questions that could be asked of the system:

For each appointment:
Was the sales rep on time for the appointment?
Did the sales rep:
   Use the integrated screen share?
   Use visualization as a part of the presentation?
   Present the warranty?
   Present to the customer for at least 15 minutes?
   Email a copy of the proposal to the customer?
   Email a copy of the agreement to the customer?
   Send a document to the customer for signature?
   Use measurements for the job?
Did a viewer connect to the screen share?
Did the customer open the agreement?
Did the customer sign the agreement?

How does the use of visualization affect the closing rate?

How does the presentation of the warranty affect the closing rate?

How does the use of the screen share affect closing rate?

What is the average time it takes to create an estimate without integrated measurements?

What is the average time it takes to create an estimate when using integrated measurements?

What is the average turnaround time for document execution?

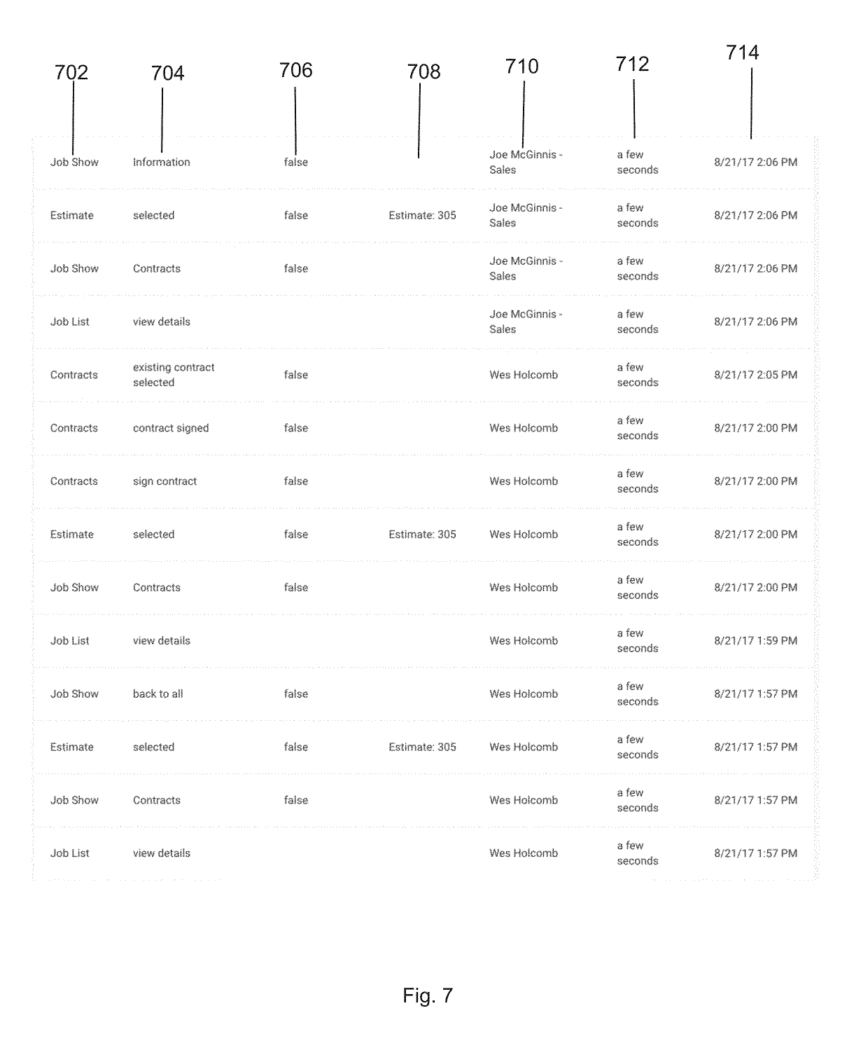

Alternatively, the analytics can be reported in a full verbose listing of all event data to allow a user to report on the full interaction of the sales rep with the job/estimate. FIG. 7 depicts an exemplary verbose analytics event listing. As illustrated, the type of job can be depicted at 702, a task can be depicted at 704, whether the task was completed can be depicted at 706, an estimate number can be depicted at 708, the name of the salesman or customer at 710, the length of time of the task took can be depicted at 712, and the date and time of task start and/or completion can be depicted at 714.

### Estimate Templating for Building Projects

One form of the present application is directed to a process for the creation of estimate templating for building projects. This process involves the creation of templates or groups of items that are saved and used for later creation. One unique and novel portion of this process is the ability for the user to be able to create the templates for themselves, as opposed to using an off the shelf template. Although a variety of estimate template creation techniques are contemplated herein, one exemplary process for estimate creation will be discussed hereinafter.

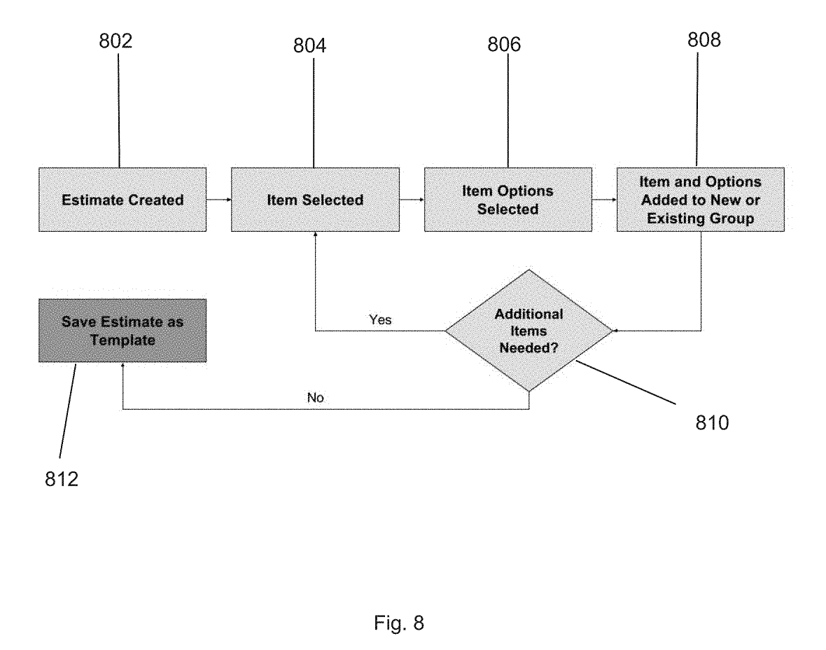

FIG. 8 depicts an exemplary estimate template creation process overview. An estimate is created at 802. One or more items are selected at 804 and item options are selected at 806. Whether the item and options are added to a new or existing group is determined at 808. Whether additional items are needed is determined at 810. When the estimate is complete and no additional items are needed, save estimate as template can be selected at 812.

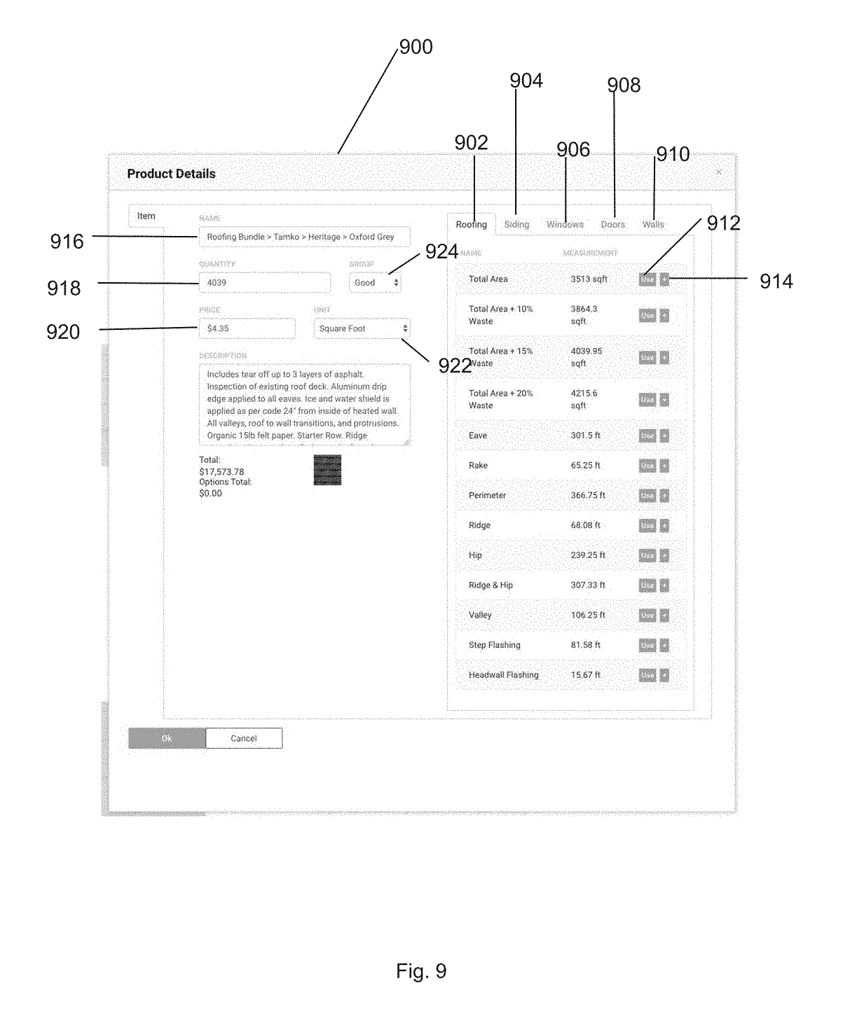

To create an estimate 802 in the system an existing estimate can be used as well as and selected items/options/documents/photos/images for template purposes. To add or select an item 804, the item can be selected from an appropriate price list in the system. FIG. 9 depicts an exemplary graphical user interface 900 demonstrating a selected product example. As is illustrated, a user can select roofing 902, siding 904, windows 906, doors 908, walls 910. As was discussed previously, the measurement can be selected 912 or added to 914 or subtracted from (not shown). The name of the product can be entered or selected at 916, the quantity is displayed at 918, the price is displayed at 920 and the unit of price is displayed at 922, A product grouping is depicted at 924 (in this case good).

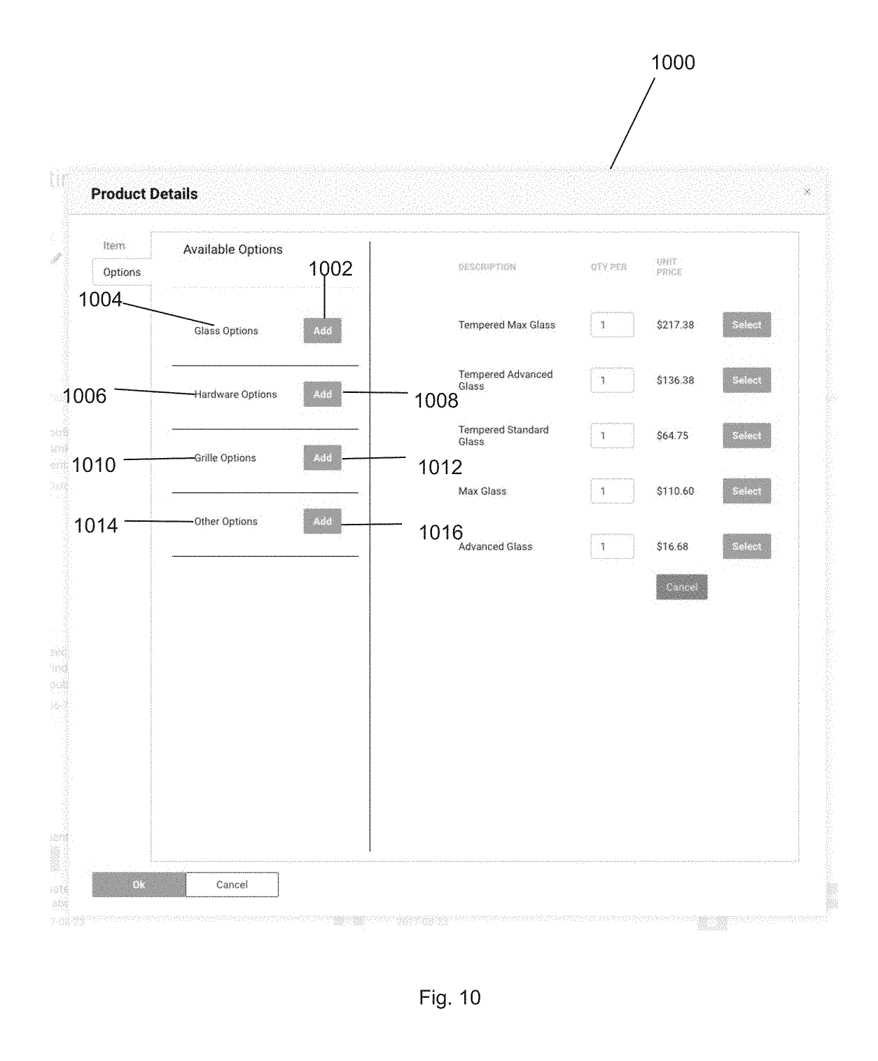

FIG. 10 depicts a variety of options for a specific product. As would be understood to a person of skill in the art, the available options are dependent upon the specific product. For example, in the case of an item such as a window, the user could select a variety of glass options 1004. To view the various glass options, a user can select “add” 1002 corresponding to the glass options. For a user to view hardware options 1006 a user could select “add” next to hardware options. For a user to view and select various grille options 1010 a user can select “add” 1012, For a user to view other options 1014, the user can select “add” 1016. Alternatively, if the product is a roof, options for underlayment, whether 3-D or architectural shingles will be utilized, warranty, or the like could be displayed.

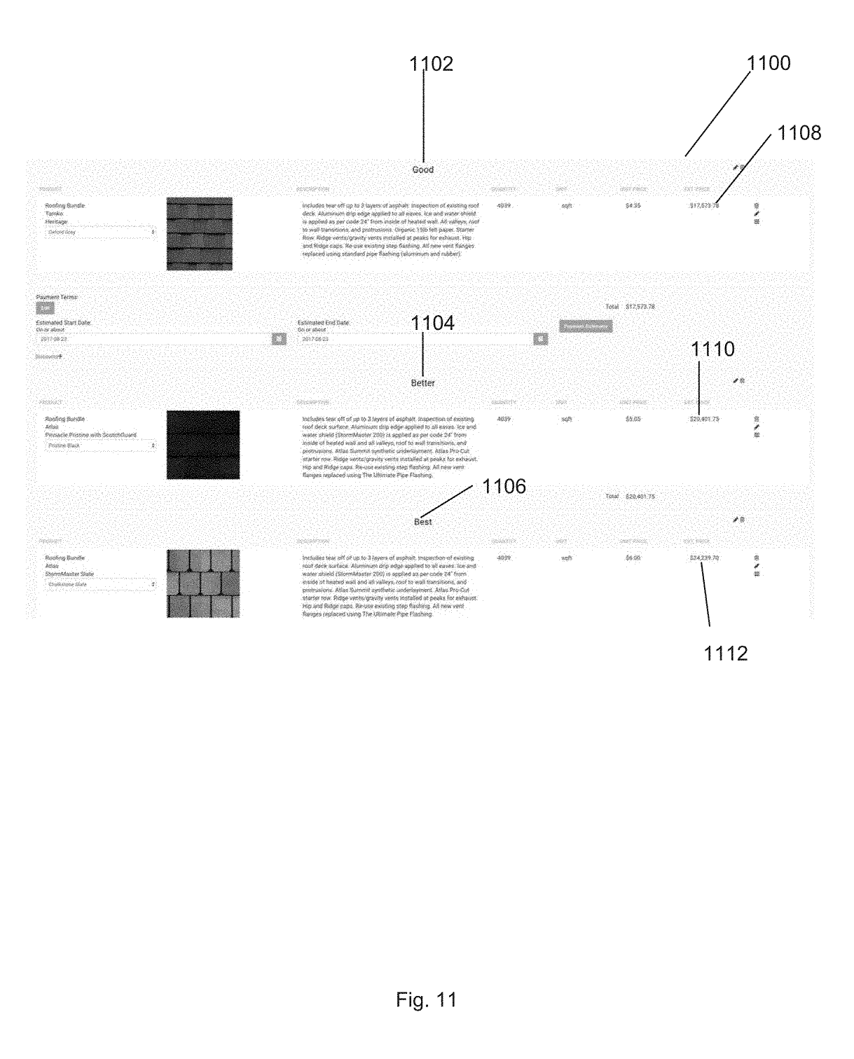

Once all selections have been made, the user has the ability to add the product to either a new or existing group of products on the estimate. FIG. 11 depicts an estimate group 924 example on as it would appear to a user. This exemplary grouping 1100, includes a good 1102 product selection and associated cost 1108, a better 1104 product selection and associated cost 1110, and a best product selection and associated cost 1112. As would be understood to a person of ordinary skill in the art, these groupings can be utilized however a user sees fit. For example, rather than utilizing good, better, best, the groupings could include bronze, silver, and gold. Alternatively, the groupings could be performed by product type roofing, siding, windows, cabinets, plumbing, etc.

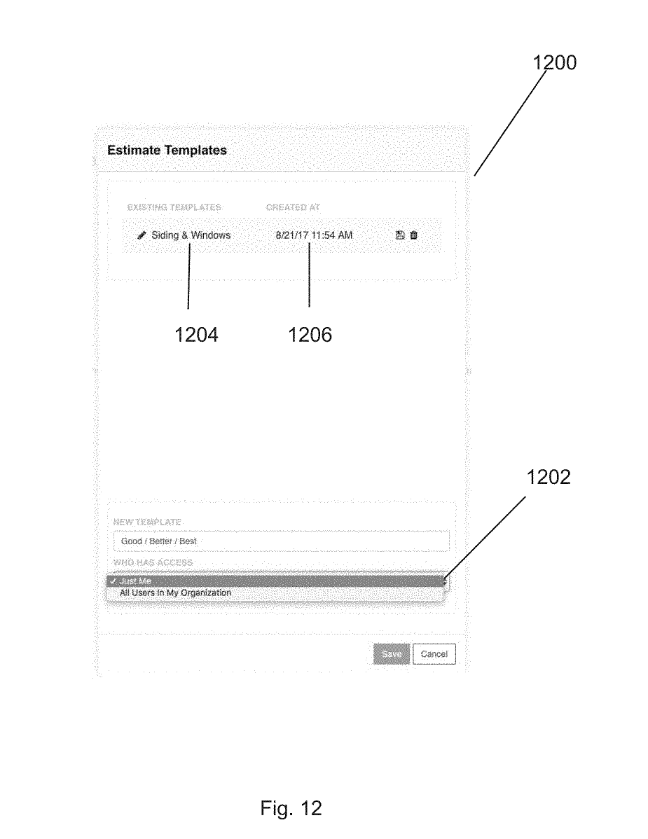

Once all items have been added to the estimate, the user can then choose the option to “Save As Template”. FIG. 12 depicts a “Save As Template” 1200. In this “Save As Template” 1200 the user has the option to save as an existing template at 1204 which also displays the date and time the template was created 1206. The user can also provide additional data to the template such as “Who has access” at 1202, a user or customer name, or the like.

Once the user selects to save the template, the template is added to the system for future estimates.

When creating estimates, a user the ability to select from any available estimate templates in the system. This list of estimate templates would be filtered based on the user's permissions. This means that if an administrator has said a user only has access to estimate templates they've created themselves, the system would only list those templates which they have created. However, if the administrator has deemed it appropriate for the user to see not only their templates but also templates that others in the system have classified as “public” templates they would see those as well. The user then has the ability to select that template from a predefined list.

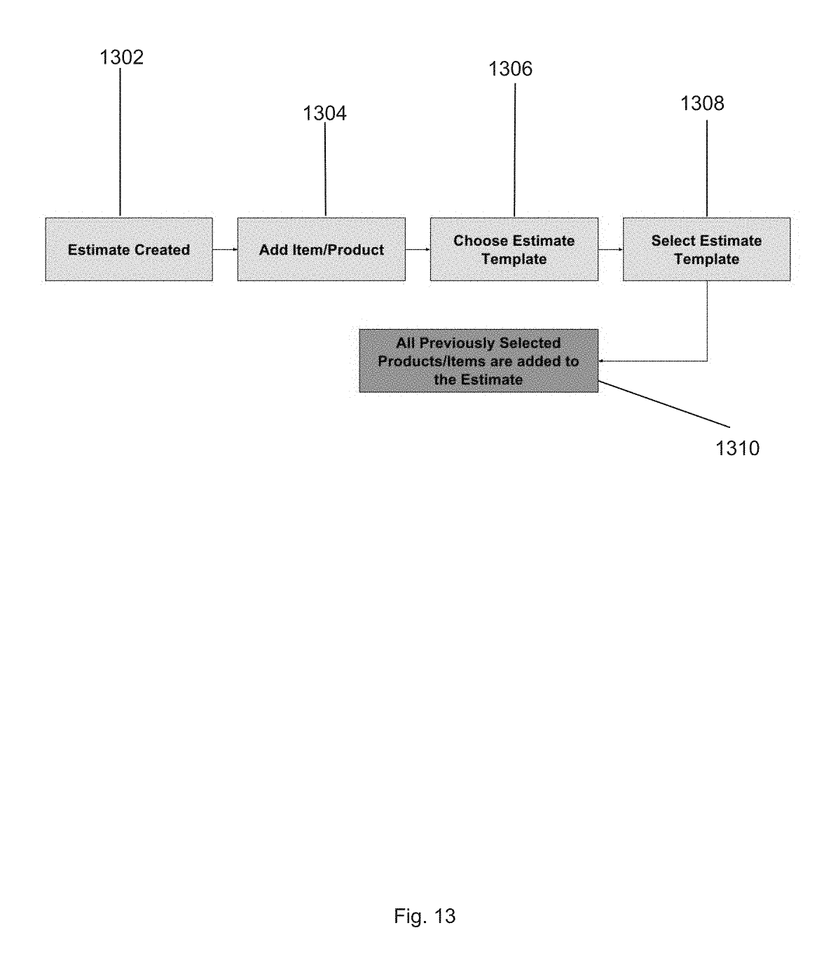

FIG. 13 depicts a “Use Existing Template” process flow diagram. A user can create a new (or load an existing) estimate at 1302. The user can then add an item or product at 1304. The user can then choose an estimate template at 1306 from those estimate templates which are saved to the system. The user will select the estimate template at 1308 and all previously selected products/items are added to the selected estimate template at 1310. In this manner a user can view how an estimate will look in multiple templates to determine the best suited estimate template for the project.

### System and Method for Automatic Inclusion of Additional Product Information in a Document

A process for the automatic inclusion of a document, such a product brochure, to a proposal, such as an estimate, agreement, or contract, will now be discussed. In this manner, when a proposal document is generated the system will automatically find and include those additional documents automatically.

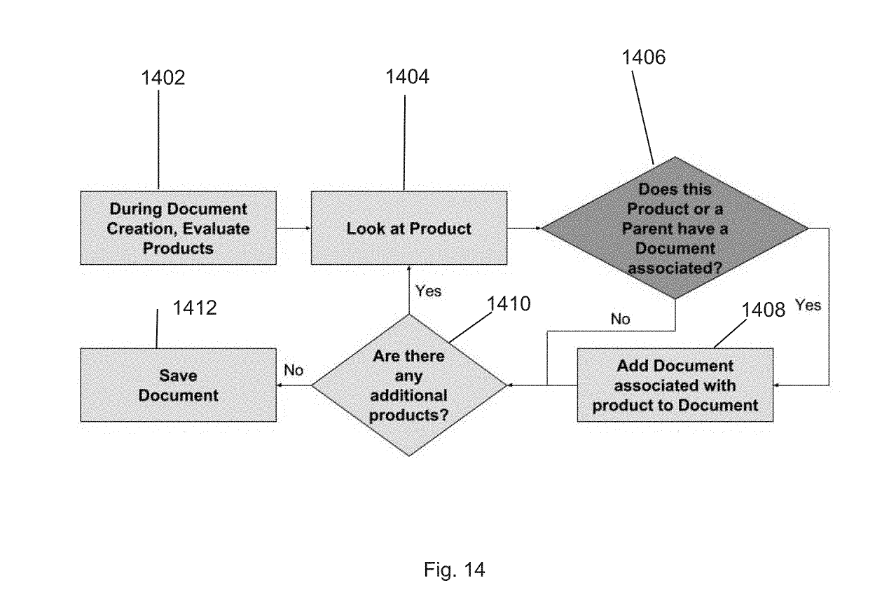

FIG. 14 depicts a flow diagram for an automatic document inclusion process. During document creation, evaluate products is depicted at 1402. Look at product is depicted at 1404. Does this product or a parent have a document associated is determined at 1406. It yes, add document associated with product to document is performed at 1408. If no, are there any additional products is determined at 1404. Save document can be performed at 1412.

The process of identifying and determining if a product has an applicable document for retrieval purposes will now be described. There are multiple ways of identification, a few examples are listed below:

Manually identifying (or attaching) a document directly to a product.
This could be done by allowing the user to upload a document directly to the product itself.
This could also be done by an administrator by associating (or uploading/attaching) a document to the product in the price list.
In this example the document would only be included in the document when Manufacturer A>Product 1>Color X was included in the document.

Automatically traversing a product tree to find an applicable document.
In the case of a product tree that involves parent and child relationships the process for identification can be a little more complicated.
The system would be able to traverse up the tree to include all applicable documents for that product.
   The system can automatically include the document when the following Products are included in the document:
      Manufacturer A>Product 1>Color X
      Manufacturer A>Product 1>Color Y
      Manufacturer A>Product 1>Color Z
   However, the system would NOT include the document if the following products were selected:
      Manufacturer A>Product 2>Color X
      Manufacturer A>Product 2>Color Y
The system would be able to traverse up the tree to any level needed and include all applicable documents for that product.
   The system automatically includes the document when the following Products are included in the document:
      Manufacturer A>Product 1>Color X
      Manufacturer A>Product 1>Color Y
      Manufacturer A>Product 1>Color Z
      Manufacturer A>Product 2>Color X
      Manufacturer A>Product 2>Color Y

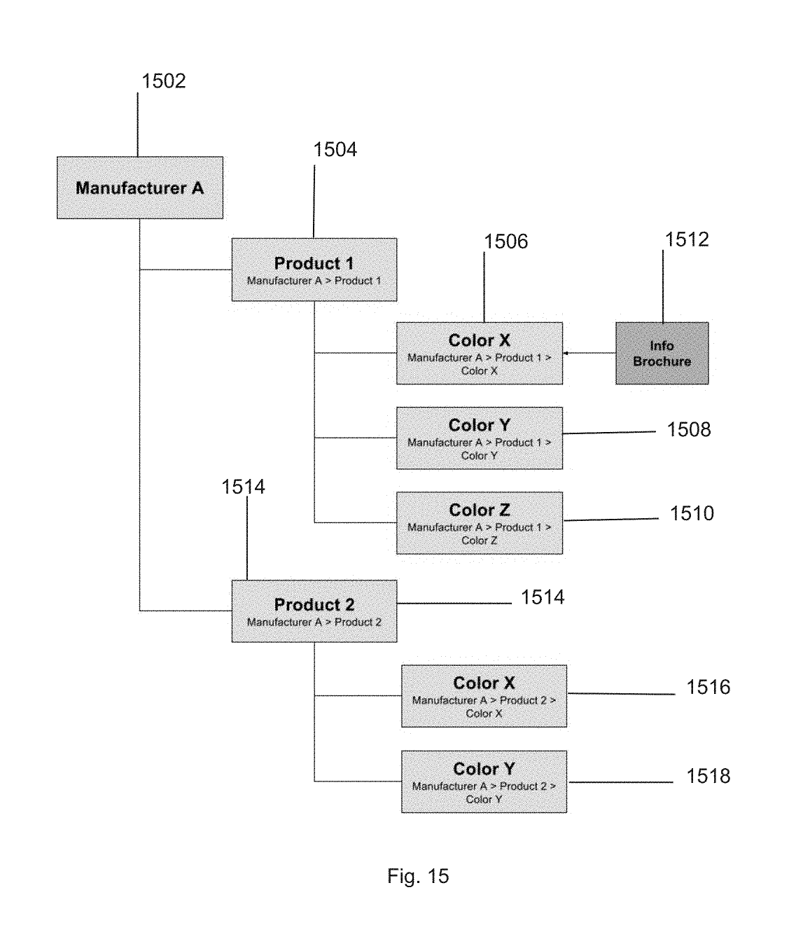

FIG. 15 depicts a schematic “product tree” having a brochure attached to a specific product. In this example, any documents generated relating to Manufacturer A 1502, Product 1 1504, Color X 1506 will include document 1512, depicted as an information brochure. However, documents generated related to Manufacturer A 1502, Product 1 1504, Color Y 1508 or Color Z 1510 will not include document 1512. Moreover, any documents generated with regard to Manufacturer A 1502, Product 21514, Color X 1516 or Color Y 1518 will also not include document 1512.

Therefore, the location that the document 1512 is associated with the product tree determines whether document 1512 will be included with any other product document generation. For example, if the document 1512 was attached to Manufacturer A 1502, then any documents generated with regard to Manufacturer A 1502, Product 1 1504 or Product 2 1514 will include document 1512 attached thereto.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a, ” “an” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A system for the estimation of building materials, comprising:
a remote terminal associated with a construction product estimator, wherein the remote terminal is configured to be placed in communication with a server via an Internet based communication network;
a measurement data repository application accessible from the remote terminal and configured to generate a measurement import page on the remote terminal, wherein the measurement import page includes a category of measurement input field that is operable to allow the construction estimator to input a category of measurement, wherein the measurement import page further includes a measurement value input field that is operable to allow the construction estimator to input a measurement value, and wherein the measurement data repository is configured to store the category of measurement and the measurement value on the terminal;
a product pricing data repository application accessible from the remote terminal configured to store product pricing data and product measurement data, wherein the product pricing data repository application is configured to update the product pricing data and product measurement data on the remote terminal with product pricing data and product measurement data from the server; and
a generate estimate application accessible from the remote terminal that is configured to generate an estimate on the remote terminal in response to the category of measurement, the measurement value, the product pricing data, and the product measurement data.

2. The system of claim 1, wherein the category of measurement input field further comprises a user selectable icon structured to allow an estimator to select a category of measurement taken, and wherein the, category of measurement is selected from at least one of interior, exterior, roofing, cabinets, flooring, siding, gutters, and windows.

3. The system of claim 1, wherein the measurement import page includes a unit of measure input field operable to allow the construction estimator to input the unit of measure for the measurement value.

4. The system of claim 3, further comprising a unit of measure conversion application associated with the remote terminal, wherein the unit of measure conversion application is configured to convert units of the measurement value to units of the product measurement data.

5. The system of claim 1, wherein the product pricing data repository application further comprises a waste determination function configured to determine an estimated waste for a project based on at least one of a type of project, a project size, and historical project waste data.

6. A system for analytics and reporting of sales of building improvement products, comprising:
a remote terminal associated with a building product salesperson, wherein the remote terminal is configured to be placed in communication with a server via an Internet based communication network;
an event data application associated with the terminal and configured to receive event data entered by the building product salesperson onto the terminal;
an event data storage application associated with the terminal and configured to assign the event data to at least one task, and wherein the event data storage application is further configured to store the event data on the terminal; and,
an analytics report, generation application associated with the terminal, and wherein the analytics report generation application is configured to generate an, analytics report displaying at least a portion of the event data from the event data storage application.

7. The system of claim 6, wherein the event data storage application is further configured to associate the event data and task to at least one of an estimate identifier and a customer identifier, and wherein the event data storage application is further configured to upload the event data to the server.

8. The system of claim 6, wherein the analytics report generation application is further configured to display event items as completed, pending, or not completed through visual icons and color coding.

9. The system of claim 6, wherein the event data comprises at least one of date and time of estimate creation, date and time of estimate building, sending an estimate. sending an appointment invitation, opening a presentation, if an agreement was sent, and if the agreement was executed by all users.
